(19) United States
(12) Patent Application Publication
(10) Pub. No.: US 2022/0372663 A1
(43) Pub. Date: Nov. 24, 2022

(54) CORE-SHEATH COMPOSITE FIBER FOR ARTIFICIAL HAIR, AND HEADWEAR PRODUCT INCLUDING SAME

(71) Applicant: KANEKA CORPORATION, Osaka (JP)

(72) Inventor: Yurina Ino, Osaka (JP)

(73) Assignee: KANEKA CORPORATION, Osaka (JP)

(21) Appl. No.: 17/881,823

(22) Filed: Aug. 5, 2022

Related U.S. Application Data
(63) Continuation of application No. PCT/JP2021/000042, filed on Jan. 5, 2021.

(30) Foreign Application Priority Data
Mar. 3, 2020 (JP) 2020-036161

(51) Int. Cl. D01F 1/07; C09K 21/02; C09K 21/14; D01F 8/14; D01F 8/12; A41G 3/00; A41G 5/00

(52) U.S. Cl. CPC D01F 1/07; C09K 21/02; C09K 21/14; D01F 8/14; D01F 8/12; A41G 3/00; A41G 5/004; D10B 2503/08; D10B 2401/04

(57) ABSTRACT

A core-sheath conjugate fiber for artificial hair having a core-sheath structure including a core part and a sheath part is provided. Both the core part and the sheath part contain a bromine-based flame retardant and a flame retardant auxiliary. The core part includes a core part resin composition containing the bromine-based flame retardant and the flame retardant auxiliary in a total amount of 20 parts by weight or more and 40 parts by weight or less with respect to 100 parts by weight of a main component resin. The sheath part includes a sheath part resin composition containing the bromine-based flame retardant and the flame retardant auxiliary in a total amount of 10 parts by weight or more and 25 parts by weight or less with respect to 100 parts by weight of a main component resin.

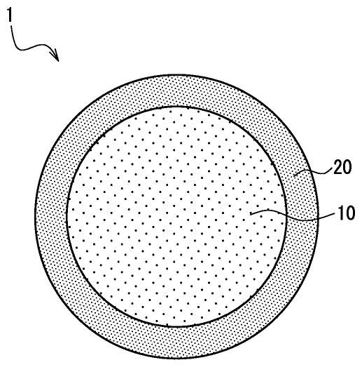

### TECHNICAL FIELD

One or more embodiments of the present invention relate to a core-sheath conjugate fiber for artificial hair having a core-sheath structure and capable of being used as an alternative to human hair and a hair ornament product including the same.

### BACKGROUND

Conventionally, human hair is used for hair ornament products such as hairpieces, hair wigs, hair extensions, hair bands, and doll hair. However, in recent years, it is becoming difficult to obtain human hair and its price is increasing, and thus there is an increasing demand for artificial hair capable of being used as an alternative to human hair. Examples of synthetic fibers that can be used for artificial hair include acrylic-based fibers, vinyl chloride-based fibers, vinylidene chloride-based fibers, polyester-based fibers, polyamide-based fibers, and polyolefin-based fibers.

Artificial hair is required to have a touch and appearance close to those of human hair. For example, Patent Document 1 describes, as a core-sheath conjugate fiber for artificial hair having an appearance and texture such as a touch and feel close to those of natural hair, a core-sheath conjugate fiber in which a semi-aromatic polyamide component is used for a core part and a linear saturated aliphatic polyamide component is used for a sheath part.

Furthermore, in recent years, there is demand for imparting flame retardance to fibers for artificial hair. For example, Patent Document 2 describes adding a bromine-based flame retardant and a flame retardant auxiliary to a core part resin composition and a sheath part resin composition in a fiber for artificial hair having a core-sheath structure including a core part made of the core part resin composition containing polyester and a sheath part made of the sheath part resin composition containing polyamide.

### PATENT DOCUMENT

Patent Document 1: WO 2006/087911

Patent Document 2: WO 2017/187843

However, the inventor of one or more embodiments of the present invention found that when a flame retardant is added to a core-sheath conjugate fiber for artificial hair having the core-sheath structure, there are problems of the combing property and the gloss being impaired.

In order to address the above, one or more embodiments of the present invention provide a core-sheath conjugate fiber for artificial hair having good flame retardance and good combing property while having a touch and gloss close to those of human hair, and a hair ornament product including the same.

### SUMMARY

One or more embodiments of the present invention relate to a core-sheath conjugate fiber for artificial hair including a core part and a sheath part, wherein both the core part and the sheath part contain a bromine-based flame retardant and a flame retardant auxiliary, the core part is comprised of a core part resin composition that contains the bromine-based flame retardant and the flame retardant auxiliary in a total amount of 20 parts by weight or more and 40 parts by weight or less with respect to 100 parts by weight of a main component resin, the sheath part is comprised of a sheath part resin composition that contains the bromine-based flame retardant and the flame retardant auxiliary in a total amount of 10 parts by weight or more and 25 parts by weight or less with respect to 100 parts by weight of a main component resin, and when the total amount of the main component resin of the core part and the main component resin of the sheath part is taken as 100 parts by weight, the core-sheath conjugate fiber for artificial hair contains the bromine-based flame retardant and the flame retardant auxiliary in a total amount of 10 parts by weight or more and 35 parts by weight or less.

Furthermore, one or more embodiments of the present invention relate to a hair ornament product including the core-sheath conjugate fiber for artificial hair.

According to one or more embodiments of the present invention, it is possible to provide a core-sheath conjugate fiber for artificial hair having good flame retardance and good combing property while having a touch and gloss close to those of human hair, and a hair ornament product including the same.

### BRIEF DESCRIPTION OF THE DRAWINGS

The FIGURE is a schematic view showing a cross section of a core-sheath conjugate fiber for artificial hair according to one or more embodiments of the present invention.

### DETAILED DESCRIPTION

The inventor of one or more embodiments of the present invention conducted an in-depth research in order to address the above, and found that a core-sheath conjugate fiber for artificial hair having good flame retardance and good combing property while having a touch and gloss close to those of human hair can be obtained when, in a core-sheath conjugate fiber for artificial hair having a core-sheath structure: both a core part and a sheath part contain a bromine-based flame retardant and a flame retardant auxiliary; the core part is comprised of a core part resin composition that contains the bromine-based flame retardant and the flame retardant auxiliary in a total amount of 20 parts by weight or more and 40 parts by weight or less with respect to 100 parts by weight of a main component resin; the sheath part is comprised of a sheath part resin composition that contains the bromine-based flame retardant and the flame retardant auxiliary in a total amount of 10 parts by weight or more and 25 parts by weight or less with respect to 100 parts by weight of a main component resin; and the bromine-based flame retardant and the flame retardant auxiliary are contained in a total amount of 10 parts by weight or more and 35 parts by weight or less when the total amount of the main component resin of the core part and the main component resin of the sheath part is taken as 100 parts by weight.

### Structure of Core-Sheath Conjugate Fiber

The core-sheath conjugate fiber for artificial hair has a core-sheath structure including a core part and a sheath part. It is sufficient that the core part is inside the sheath part, and the core-sheath structure may be a concentric structure in which the center point of the core part coincides with the center point of the fiber or an eccentric structure in which the center point of the core part does not coincide with the center point of the fiber and is situated away therefrom. The core-sheath conjugate fiber for artificial hair may have a circular cross sectional shape, an elliptical cross sectional shape, or any other cross sectional shape such as a multilobed cross sectional shape. Also, the core part may have a circular cross sectional shape, an elliptical cross sectional shape, or any other cross sectional shape such as a multilobed cross sectional shape. The cross sectional shape of the core-sheath conjugate fiber for artificial hair may be the same as or differ from the cross sectional shape of the core part. The FIGURE is a schematic view showing a cross section of the core-sheath conjugate fiber for artificial hair according to one or more embodiments of the present invention. The core-sheath conjugate fiber 1 for artificial hair includes a core part 10 and a sheath part 20 and has a concentric structure in which the core part is concentrically arranged such that the center point of the core part coincides with the center point of the fiber, and the cross sectional shape of the core-sheath conjugate fiber 1 for artificial hair and the cross sectional shape of the core part 10 are both circular shapes.

The core-to-sheath area ratio between the core part and the sheath part may be in the range of core:sheath=2:8 to 7:3, or in the range of 3:7 to 6:4. If the core-to-sheath area ratio is in this range, the two components are unlikely to separate from each other, and it is easy to shape the core-sheath conjugate fiber.

### Composition of Core-Sheath Conjugate Fiber for Artificial Hair

From the viewpoint of obtaining a touch and gloss closer to those of human hair and further improving the combing property and flame retardance, it is more preferable that the core part of the core-sheath conjugate fiber for artificial hair is comprised of a polyester-based resin composition containing, as a main component resin, one or more of polyester-based resins selected from the group consisting of polyalkylene terephthalate and a copolymerized polyester mainly containing polyalkylene terephthalate, and the sheath part thereof is comprised of a polyamide-based resin composition containing, as a main component resin, a polyamide-based resin mainly containing at least one selected from the group consisting of Nylon 6 and Nylon 66.

Both the core part and the sheath part contain a bromine-based flame retardant and a flame retardant auxiliary. Accordingly, the core-sheath conjugate fiber for artificial hair exhibits improved flame retardance and has good gloss and excellent combing property.

When the total amount of the main component resin of the core part and the main component resin of the sheath part is taken as 100 parts by weight, the core-sheath conjugate fiber for artificial hair contains the bromine-based flame retardant and the flame retardant auxiliary in a total amount of 10 parts by weight or more and 35 parts by weight or less. Accordingly, the core-sheath conjugate fiber for artificial hair exhibits good flame retardance and has a touch and gloss close to those of human hair and good combing property. From the viewpoint of enhancing flame retardance, when the total amount of the main component resin of the core part and the main component resin of the sheath part is taken as 100 parts by weight, the core-sheath conjugate fiber for artificial hair contains the bromine-based flame retardant and the flame retardant auxiliary in a total amount of preferably 20 parts by weight or more, and more preferably 21 parts by weight or more. From the viewpoint of improving the combing property, when the total amount of the main component resin of the core part and the main component resin of the sheath part is taken as 100 parts by weight, the core-sheath conjugate fiber for artificial hair contains the bromine-based flame retardant and the flame retardant auxiliary in a total amount of preferably 30 parts by weight or less, and more preferably 29 parts by weight or less.

When the total amount of the main component resin of the core part and the main component resin of the sheath part in the core-sheath conjugate fiber for artificial hair is taken as 100 parts by weight, the amount of the main component resin of the core part and the amount of the main component resin of the sheath part in the core-sheath conjugate fiber for artificial hair is calculated based on the core-to-sheath area ratio. For example, when the core-to-sheath area ratio is 5:5, the amount of the main component resin of the core part is 50 parts by weight, and the amount of the main component resin of the sheath part is 50 parts by weight. When the core-to-sheath area ratio is 7:3, the amount of the main component resin of the core part is 70 parts by weight, and the amount of the main component resin of the sheath part is 30 parts by weight.

From the viewpoint of improving flame retardance, when the total amount of the main component resin of the core part and the main component resin of the sheath part is taken as 100 parts by weight, the core-sheath conjugate fiber for artificial hair contains the bromine-based flame retardant in an amount of preferably 15 parts by weight or more and 25 parts by weight or less, and more preferably 18 parts by weight or more and 24 parts by weight or less.

From the viewpoint of improving flame retardance, when the total amount of the main component resin of the core part and the main component resin of the sheath part is taken as 100 parts by weight, the core-sheath conjugate fiber for artificial hair contains the flame retardant auxiliary in an amount of preferably 1.0 part by weight or more and 5 parts by weight or less, and more preferably 1.2 parts by weight or more and 4 parts by weight or less.

From the viewpoint of improving flame retardance while improving the touch, gloss, and combing property of the core-sheath conjugate fiber for artificial hair more effectively, the total amount of the bromine-based flame retardant and the flame retardant auxiliary with respect to 100 parts by weight of the main component resin in the sheath part resin composition may be smaller than the total amount of the bromine-based flame retardant and the flame retardant auxiliary with respect to 100 parts by weight of the main component resin in the core part resin composition. Particularly in the case where the main component resin of the sheath part is a polyamide-based resin, a core-sheath conjugate fiber for artificial hair that has more natural gloss and remarkably excellent touch is likely to be obtained when the amounts of the bromine-based flame retardant and the flame retardant auxiliary in the sheath part are reduced while the amounts of the bromine-based flame retardant and the flame retardant auxiliary in the core part are increased to improve flame retardance of the core-sheath conjugate fiber for artificial hair.

### Flame Retardant and Flame Retardant Auxiliary in Core Part

The core part resin composition constituting the core part contains the bromine-based flame retardant and the flame retardant auxiliary in a total amount of 20 parts by weight or more and 40 parts by weight or less with respect to 100 parts by weight of the main component resin. Accordingly, the core-sheath conjugate fiber for artificial hair has good gloss, flame retardance, and combing property while having a touch close to that of human hair. The “main component resin of the core part” means a resin with the highest content among resins contained in the core part resin composition, and when the total amount of resins contained in the core part resin composition is taken as 100% by weight, the content of the main component resin is more than 50% by weight, preferably 70% by weight or more, more preferably 85% by weight or more, further preferably 90% by weight or more, yet more preferably 95% by weight or more, and particularly preferably 100% by weight.

From the viewpoint of achieving good gloss and flame retardance at the same time, the core part resin composition may contain the bromine-based flame retardant in an amount of 20 parts by weight or more and 35 parts by weight or less with respect to 100 parts by weight of the main component resin, although there is no limitation thereto.

From the viewpoint of achieving good gloss and flame retardance at the same time, the core part resin composition may contain the flame retardant auxiliary in an amount of 2 parts by weight or more and 5 parts by weight or less with respect to 100 parts by weight of the main component resin, although there is no limitation thereto.

### Flame Retardant and Flame Retardant Auxiliary in Sheath Part

The sheath part resin composition constituting the sheath part contains the bromine-based flame retardant and the flame retardant auxiliary in a total amount of 10 parts by weight or more and 25 parts by weight or less with respect to 100 parts by weight of the main component resin. Accordingly, the core-sheath conjugate fiber for artificial hair has good flame retardance and combing property while having a touch and gloss close to those of human hair. From the viewpoint of obtaining a touch and gloss closer to those of human hair and further enhancing the combing property, the sheath part resin composition constituting the sheath part contains the bromine-based flame retardant and the flame retardant auxiliary in a total amount of preferably 20 parts by weight or less, more preferably 18 parts by weight or less, and further preferably 16 parts by weight or less, with respect to 100 parts by weight of the main component resin. The “main component resin of the sheath part” means a resin with the highest content among resins contained in the sheath part resin composition, and when the total amount of resins contained in the sheath part resin composition is taken as 100% by weight, the content of the main component resin is more than 50% by weight, preferably 70% by weight or more, more preferably 85% by weight or more, further preferably 90% by weight or more, yet more preferably 95% by weight or more, and particularly preferably 100% by weight.

From the viewpoint of achieving good touch and flame retardance at the same time, the sheath part resin composition contains the bromine-based flame retardant in an amount of preferably 10 parts by weight or more and 20 parts by weight or less, and more preferably 12 parts by weight or more and 18 parts by weight or less, with respect to 100 parts by weight of the main component resin, although there is no limitation thereto.

From the viewpoint of achieving good touch and flame retardance at the same time, the sheath part resin composition contains the flame retardant auxiliary in an amount of preferably 1 part by weight or more and 3 parts by weight or less, and more preferably 1.5 parts by weight or more and 2.5 parts by weight or less, with respect to 100 parts by weight of the main component resin, although there is no limitation thereto.

### Core Part Resin Composition

The core part resin composition is not particularly limited, and may contain, as the main component resin, at least one resin selected from the group consisting of a polyester-based resin, a polyamide-based resin, a modacrylic-based resin, a polycarbonate-based resin, a polyolefin-based resin, a polyphenylenesulfide-based resin, and the like, for example. From the viewpoint of flame retardance and gloss, the core part resin composition may be a polyester-based resin composition containing a polyester-based resin as the main component resin, and may be a polyester-based resin composition containing, as the main component resin, one or more of polyester-based resins selected from the group consisting of polyalkylene terephthalate and a copolymerized polyester mainly containing polyalkylene terephthalate. The polyester-based resin composition may further contain other resins in addition to the polyester-based resin serving as the main component resin. When the total amount of resins in the polyester-based resin composition is taken as 100% by weight, the polyester-based resin serving as the main component resin is contained in an amount of preferably more than 50% by weight, more preferably 70% by weight or more, even more preferably 85% by weight or more, even more preferably 90% by weight or more, even more preferably 95% by weight or more, and particularly preferably 100% by weight.

Polyalkylene terephthalate is not particularly limited, and may be, for example, polyethylene terephthalate, polypropylene terephthalate, polybutylene terephthalate, or polycyclohexane dimethylene terephthalate. The copolymerized polyester mainly containing polyalkylene terephthalate is not particularly limited, and maybe, for example, a copolymerized polyester mainly containing polyalkylene terephthalate such as polyethylene terephthalate, polypropylene terephthalate, polybutylene terephthalate, or polycyclohexane dimethylene terephthalate, and further containing other copolymerizable components. The “copolymerized polyester mainly containing polyalkylene terephthalate” refers to a copolymerized polyester containing polyalkylene terephthalate in an amount of 80 mol % or more.

Examples of the other copolymerizable components include: polycarboxylic acids such as isophthalic acid, orthophthalic acid, naphthalenedicarboxylic acid, paraphenylenedicarboxylic acid, trimellitic acid, pyromellitic acid, succinic acid, glutaric acid, adipic acid, suberic acid, azelaic acid, sebacic acid, and dodecanedioic acid, and their derivatives; dicarboxylic acids and their derivatives containing sulfonates such as 5-sodiumsulfoisophthalic acid and dihydroxyethyl 5-sodiumsulfoisophthalate; 1,2-propanediol; 1,3-propanediol; 1,4-butanediol; 1,6-hexanediol; neopentyl glycol; 1,4-cyclohexanedimethanol; diethylene glycol; polyethylene glycol; trimethylolpropane; pentaerythritol; 4-hydroxybenzoic acid; ε-caprolactone; and an ethylene glycol ether of bisphenol A.

The copolymerized polyester may be produced by adding a small amount of other copolymerizable components to polyalkylene terephthalate serving as a main component, and allowing them to react with each other, from the viewpoint of stability and ease of operation. Examples of the polyalkylene terephthalate include a polymer of terephthalic acid and/or its derivatives (e.g., methyl terephthalate) and alkylene glycol. The copolymerized polyester may be produced by adding a small amount of monomer or oligomer component serving as other copolymerizable components, to a mixture of terephthalic acid and/or its derivatives (e.g., methyl terephthalate) and alkylene glycol, used for polymerization of polyalkylene terephthalate serving as a main component, and subjecting them to polymerization.

It is sufficient that the copolymerized polyester has a structure in which the other copolymerizable components are polycondensed on the main chain and/or side chain of polyalkylene terephthalate serving as a main component, and the copolymerization method and the like are not particularly limited.

Specific examples of the copolymerized polyester mainly containing polyalkylene terephthalate include a polyester obtained through copolymerization of polyethylene terephthalate serving as a main component with one compound selected from the group consisting of an ethylene glycol ether of bisphenol A, 1,4-cyclohexanedimethanol, isophthalic acid, and dihydroxyethyl 5-sodiumsulfoisophthalate.

Polyalkylene terephthalate and the copolymerized polyester mainly containing polyalkylene terephthalate may be used alone or in a combination of two or more. In particular, polyethylene terephthalate (hereinafter also referred to as “PET”); polypropylene terephthalate; polybutylene terephthalate (hereinafter also referred to as “PBT”); a polyester obtained through copolymerization of polyethylene terephthalate serving as a main component with an ethylene glycol ether of bisphenol A; a polyester obtained through copolymerization of polyethylene terephthalate serving as a main component with 1,4-cyclohexanedimethanol; a polyester obtained through copolymerization of polyethylene terephthalate serving as a main component with isophthalic acid; a polyester obtained through copolymerization of polyethylene terephthalate serving as a main component with dihydroxyethyl 5-sodiumsulfoisophthalate, and the like may be used alone or in a combination of two or more, and polyethylene terephthalate; a polyester obtained through copolymerization of polyethylene terephthalate serving as a main component with an ethylene glycol ether of bisphenol A; a polyester obtained through copolymerization of polyethylene terephthalate serving as a main component with 1,4-cyclohexanedimethanol; a polyester obtained through copolymerization of polyethylene terephthalate serving as a main component with isophthalic acid; a polyester obtained through copolymerization of polyethylene terephthalate serving as a main component with dihydroxyethyl 5-sodiumsulfoisophthalate, and the like may be used alone or in a combination of two or more.

The intrinsic viscosity (IV value) of the polyester-based resin is not particularly limited, but it may be 0.3 or more and 1.2 or less, or 0.4 or more and 1.0 or less. If the intrinsic viscosity is 0.3 or more, the mechanical strength of the obtained fiber does not decrease, and there is no risk of dripping during a combustion test. On the other hand, if the intrinsic viscosity is 1.2 or less, the molecular weight is not too large, and the melt viscosity is not too high, and thus it is easy to perform melt spinning, and the fineness is likely to be uniform.

### Sheath Part Resin Composition

The sheath part resin composition is not particularly limited, and may contain, as the main component resin, at least one resin selected from the group consisting of a polyester-based resin, a polyamide-based resin, a modacrylic-based resin, a polycarbonate-based resin, a polyolefin-based resin, a polyphenylenesulfide-based resin, and the like, for example. From the viewpoint of improving the touch, the sheath part resin composition may be a polyamide-based resin composition containing a polyamide-based resin as the main component resin. The polyamide-based resin composition may further contain other resins in addition to the polyamide-based resin serving as the main component resin. When the total amount of resins in the polyamide-based resin composition is taken as 100% by weight, the polyamide-based resin serving as the main component resin is contained in an amount of preferably more than 50% by weight, more preferably 70% by weight or more, even more preferably 85% by weight or more, even more preferably 90% by weight or more, even more preferably 95% by weight or more, and particularly preferably 100% by weight.

The polyamide-based resin means a nylon resin obtained through polymerization of one or more selected from the group consisting of lactam, aminocarboxylic acid, a mixture of dicarboxylic acid and diamine, a mixture of a dicarboxylic acid derivative and diamine, and a salt of dicarboxylic acid and diamine.

Specific examples of the lactam include, but are not particularly limited to, for example, 2-azetidinone, 2-pyrrolidinone, δ-valerolactam, ε-caprolactam, enantholactam, capryllactam, undecalactam, and laurolactam. Of these lactams, it is preferable to use ε-caprolactam, undecalactam, and laurolactam, and more preferable to use ε-caprolactam. These lactams may be used alone or in a combination of two or more.

Specific examples of the aminocarboxylic acid include, but are not particularly limited to, for example, 6-aminocaproic acid, 7-aminoheptanoic acid, 8-aminooctanoic acid, 9-aminononanoic acid, 10-aminodecanoic acid, 11-aminoundecanoic acid, and 12-aminododecanoic acid. Of these aminocarboxylic acids, it is preferable to use 6-aminocaproic acid, 11-aminoundecanoic acid, and 12-aminododecanoic acid, and more preferable to use 6-aminocaproic acid. These aminocarboxylic acids may be used alone or in a combination of two or more.

Specific examples of the dicarboxylic acid that can be used for the mixture of dicarboxylic acid and diamine, the mixture of a dicarboxylic acid derivative and diamine, or the salt of dicarboxylic acid and diamine include, but are not particularly limited to, for example: aliphatic dicarboxylic acids such as oxalic acid, malonic acid, succinic acid, glutaric acid, adipic acid, pimelic acid, suberic acid, azelaic acid, sebacic acid, undecanedioic acid, dodecanedioic acid, brasylic acid, tetradecanedioic acid, pentadecanedioic acid, and octadecanedioic acid; alicyclic dicarboxylic acids such as cyclohexane dicarboxylic acid; and aromatic dicarboxylic acids such as phthalic acid, isophthalic acid, terephthalic acid, and naphthalenedicarboxylic acid. Of these dicarboxylic acids, it is preferable to use adipic acid, sebacic acid, dodecanedioic acid, terephthalic acid, and isophthalic acid, and more preferable to use adipic acid, terephthalic acid, and isophthalic acid. These dicarboxylic acids may be used alone or in a combination of two or more.

Specific examples of the diamine that can be used for the mixture of dicarboxylic acid and diamine, the mixture of a dicarboxylic acid derivative and diamine, or the salt of dicarboxylic acid and diamine include, but are not particularly limited to, for example: aliphatic diamines such as 1,4-diaminobutane, 1,5-diaminopentane, 1,6-diaminohexane, 2-methyl-1,5-diaminopentane (MDP), 1,7-diaminoheptane, 1,8-diaminooctane, 1,9-diaminononan, 1,10-diaminodecane, 1,11-diaminoundecane, 1,12-diaminododecane, 1,13-diaminotridecane, 1,14-diaminotetradecane, 1,15-diaminopentadecane, 1,16-diaminohexadecane, 1,17-diaminoheptadecane, 1,18-diaminooctadecane, 1,19-diaminononadecane, and 1,20-diaminoeicosane; alicyclic diamines such as cyclohexanediamine and bis-(4-aminohexyl)methane; and aromatic diamines such as m-xylylenediamine and p-xylylenediamine. Of these diamines, it is preferable to use an aliphatic diamine, and more preferable to use hexamethylenediamine. These diamines may be used alone or in a combination of two or more.

The polyamide-based resin (nylon resin) is not particularly limited, but it is preferable to use, for example, Nylon 6 (hereinafter also referred to as “PA6”), Nylon 66 (hereinafter also referred to as TA66″), Nylon 11, Nylon 12, Nylon 6/10, Nylon 6/12, semi-aromatic nylon containing the Nylon 6T and/or 6I unit, copolymers of these nylon resins, or the like, and it is more preferable to use a polyamide-based resin mainly containing at least one selected from the group consisting of Nylon 6 and Nylon 66. The “polyamide-based resin mainly containing at least one selected from the group consisting of Nylon 6 and Nylon 66” means a polyamide-based resin that contains Nylon 6 and/or Nylon 66 in an amount of 80 mol % or more.

The polyamide-based resin can be produced for example, using a polyamide-based resin polymerization method in which a raw material for the polyamide-based resin is heated in the presence or absence of a catalyst. During the polymerization, stirring may or may not be performed, but it is preferable to perform stirring in order to obtain a uniform product. The polymerization temperature can be set as appropriate according to the degree of polymerization, the reaction yield, and the reaction time of a target polymer, but it is preferable to set the temperature to a low temperature in consideration of the quality of a finally obtained polyamide-based resin. The reaction ratio can also be set as appropriate. The pressure is not limited, but it is preferable to reduce the pressure in the system in order to efficiently let volatile components move to the outside of the system.

The polyamide-based resin may have a terminal end that is capped by an end-capping agent such as a carboxylic acid compound or an amine compound as necessary. The concentration of terminal amino groups or terminal carboxyl groups in a nylon resin obtained when a terminal end is capped by adding monocarboxylic acid or monoamine is lower than that when such an end-capping agent is not used. On the other hand, the total concentration of terminal amino groups and terminal carboxyl groups does not change when a terminal end is capped by dicarboxylic acid or diamine, but the concentration ratio between terminal amino groups and terminal carboxyl groups changes.

Specific examples of the carboxylic acid compound include, but are not particularly limited to, for example: aliphatic monocarboxylic acids such as acetic acid, propionic acid, butyric acid, valeric acid, caproic acid, enanthic acid, caprylic acid, pelargonic acid, undecanoic acid, lauric acid, tridecanoic acid, myristic acid, myristoleic acid, palmitic acid, stearic acid, oleic acid, linoleic acid, and arachic acid; alicyclic monocarboxylic acids such as cyclohexanecarboxylic acid and methylcyclohexanecarboxylic acid; aromatic monocarboxylic acids such as benzoic acid, toluic acid, ethylbenzoic acid, and phenylacetic acid; aliphatic dicarboxylic acids such as oxalic acid, malonic acid, succinic acid, glutaric acid, adipic acid, pimelic acid, suberic acid, azelaic acid, sebacic acid, undecanedioic acid, dodecanedioic acid, brasylic acid, tetradecanedioic acid, pentadecanedioic acid, and octadecanedioic acid; alicyclic dicarboxylic acids such as cyclohexanedicarboxylic acid; and aromatic dicarboxylic acids such as phthalic acid, isophthalic acid, terephthalic acid, and naphthalenedicarboxylic acid.

Specific examples of the amine compound include, but are not particularly limited to, for example: aliphatic monoamines such as butylamine, pentylamine, hexylamine, heptylamine, octylamine, 2-ethylhexylamine, nonylamine, decylamine, undecylamine, dodecylamine, tridecylamine, tetradecylamine, pentadecylamine, hexadecylamine, octadecylamine, nonadecylamine, and icosylamine; alicyclic monoamines such as cyclohexylamine and methylcyclohexylamine; aromatic monoamines such as benzylamine and β-phenylethylamine; aliphatic diamines such as 1,4-diaminobutane, 1,5-diaminopentane, 1,6-diaminohexane, 1,7-diaminoheptane, 1,8-diaminooctane, 1,9-diaminononan, 1,10-diaminodecane, 1,11-diaminoundecane, 1,12-diaminododecane, 1,13-diaminotridecane, 1,14-diaminotetradecane, 1,15-diaminopentadecane, 1,16-diaminohexadecane, 1,17-diaminoheptadecane, 1,18-diaminooctadecane, 1,19-diaminononadecane, and 1,20-diaminoeicosane; alicyclic diamines such as cyclohexanediamine and bis-(4-aminohexyl)methane; and aromatic diamines such as xylylenediamine.

The terminal group concentration of the polyamide-based resin is not particularly limited, but the terminal amino group concentration may be high, for example, when it is necessary to increase the dyeability for fiber uses or when designing a material suitable for alloying for resin uses. On the other hand, the terminal amino group concentration may be low, for example, when it is required to suppress coloring or gelation under extended aging conditions. Furthermore, the terminal carboxyl group concentration and the terminal amino group concentration may be both low when it is required to suppress reproduction of lactam during re-melting, yarn breakage during melt spinning due to production of oligomer, mold deposit during continuous injection molding, and generation of die marks during continuous extrusion of a film. It is preferable to adjust the terminal group concentration according to the applications, but the terminal amino group concentration and the terminal carboxyl group concentration both may be 1.0×10⁻⁵ to 15.0×10⁻⁵ eq/g, 2.0×10⁻⁵ to 12.0×10⁻⁵ eq/g, or 3.0×10⁻⁵ to 11.0×10⁻⁵ eq/g.

Furthermore, the end-capping agent may be added using a method in which the end-capping agent is added simultaneously with raw materials such as caprolactam at the initial stage of polymerization, a method in which the end-capping agent is added during polymerization, a method in which the end-capping agent is added when a nylon resin in a molten state is caused to pass through a vertical stirring thin-film evaporator, or the like. The end-capping agent may be added without any treatment, or in the form of being dissolved in a small amount of solvent.

### Bromine Flame Retardant

Examples of the bromine-based flame retardant include, but are not particularly limited to, for example: a brominated epoxy-based flame retardant; bromine-containing phosphoric acid esters such as pentabromotoluene, hexabromobenzene, decabromodiphenyl, decabromodiphenyl ether, bis(tribromophenoxy)ethane, tetrabromophthalic anhydride, ethylene bis(tetrabromophthalimide), ethylene bis(pentabromophenyl), octabromotrimethylphenylindan, and tris(tribromoneopentyl)phosphate; brominated polystyrenes; brominated polybenzyl acrylates; a brominated phenoxy resin; brominated polycarbonate oligomers; tetrabromobisphenol A and tetrabromobisphenol A derivatives such as tetrabromobisphenol A-bis(2,3-dibromopropyl ether), tetrabromobisphenol A-bis(allylether), and tetrabromobisphenol A-bis(hydroxyethyl ether); bromine-containing triazine compounds such as tris(tribromophenoxy)triazine; and bromine-containing isocyanuric acid compounds such as tris(2,3-dibromopropyl)isocyanurate. Of these compounds, it is preferable to use a brominated epoxy-based flame retardant from the viewpoint of heat resistance and flame retardance.

A brominated epoxy-based flame retardant having an epoxy group or tribromophenol at a molecular end thereof may be used as a raw material. The structure of the brominated epoxy-based flame retardant after melt kneading is not particularly limited, but it is preferable that 80 mol % or more of the structure is comprised of a constituent unit represented by the chemical formula (1) below when the total number of constituent units each represented by the chemical formula (1) below and constituent units obtained by at least partially modifying the chemical formula (1) below is taken as 100 mol %. The structure of the brominated epoxy-based flame retardant may change at a molecular end thereof after melt kneading. For example, a molecular end of the brominated epoxy-based flame retardant may be substituted by a hydroxyl group, a phosphate group, a phosphoric acid group, or the like other than an epoxy group or tribromophenol, or may be bound to a polyester component through an ester group.

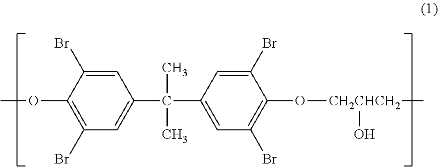

Furthermore, part of the structure of the brominated epoxy-based flame retardant, other than the molecular end, may be changed. For example, the brominated epoxy-based flame retardant may have a branched structure in which the secondary hydroxyl group and the epoxy group are bound. Also, part of the bromine of the chemical formula (1) above may be eliminated or added, as long as the bromine content in the molecules of the brominated epoxy-based flame retardant does not change significantly.

For example, a polymeric brominated epoxy-based flame retardant as represented by the general formula (2) below may be used as the brominated epoxy-based flame retardant. In the general formula (2) below, m is 1 to 1000. Examples of the polymeric brominated epoxy-based flame retardant represented by the general formula (2) below include a commercially available product such as a brominated epoxy-based flame retardant (product name “SR-T2MP”) manufactured by Sakamoto Yakuhin Kogyo Co., Ltd.

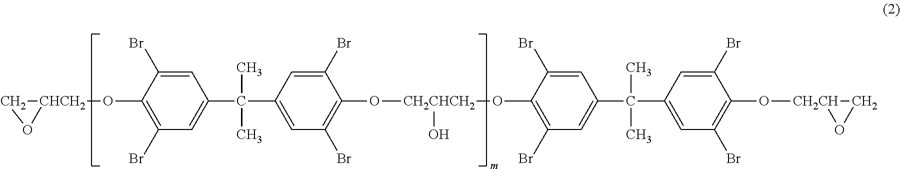

### Flame Retardant Auxiliary

The flame retardant auxiliary is not particularly limited, but it is preferable to use an antimony-based compound and a composite metal including antimony from the viewpoint of flame retardance. Examples of the antimony-based compound include antimony trioxide, antimony tetraoxide, antimony pentoxide, sodium antimonate, potassium antimonate, and calcium antimonate. It is more preferable to use one or more selected from the group consisting of antimony trioxide, antimony pentoxide, and sodium antimonate, from the viewpoint of improving the flame retardance and the influence on a touch.

As necessary, the core-sheath conjugate fiber for artificial hair may contain various types of additives such as a heat-resistant agent, a stabilizer, a fluoresces, an antioxidant, an antistatic agent, and a pigment, within a range that does not inhibit the effects of one or more embodiments of the present invention.

### Method for Producing Core-Sheath Conjugate Fiber for Artificial Hair

It is possible to produce the core-sheath conjugate fiber for artificial hair by melt-kneading and pelletizing each of the core part resin composition and the sheath part resin composition, and then performing melt spinning using a core-sheath conjugate spinneret, for example. Examples of kneaders that can be used for melt-kneading include a single-screw extruder, a twin-screw extruder, a roll, a Banbury mixer, and a kneader. Of these kneaders, it is preferable to use a twin-screw extruder from the viewpoint of adjusting the kneading degree and easily performing the operation.

In the case where the core part resin composition is a polyester-based resin composition and the sheath part resin composition is a polyamide-based resin composition, for example, melt spinning is performed by performing melt extrusion with the temperatures of an extruder, a gear pump, a spinneret, and the like set to 250° C. or more and 300° C. or less, and winding up the extruded yarns (undrawn yarns) at a speed of 30 m/min or more and 5000 m/min or less. Specifically, during the melt spinning, the core part resin composition is supplied from a core-part extruder, the sheath part resin composition is supplied from a sheath-part extruder, a molten polymer is discharged from a core-sheath conjugate spinning nozzle (pores) with a predetermined shape, and thus extruded yarns (undrawn yarns) are obtained.

Furthermore, it is possible to control the fineness by cooling the extruded yarns using a water bath containing water for cooling. The temperature and length of a heated tube, the temperature and amount of cooling air applied, the temperature of the cooling water bath, the cooling time, and the winding speed can be adjusted appropriately in accordance with the discharge amount of the polymer and the number of pores of the spinneret.

It is preferable that the extruded yarns (undrawn yarns) are drawn. The drawing may be performed by either a two-step method or a direct drawing method. In the two-step method, the extruded yarns are wound once, and then drawn. In the direct drawing method, the extruded yarns are drawn continuously without winding. The drawing may be performed by a single-stage drawing method or a multi-stage drawing method that includes two or more stages.

Heating means for the drawing may be a heating roller, a heat plate, a steam jet apparatus, or a hot water bath, which can be used in combination as desired.

It is also possible to make the touch and texture closer to those of human hair, by adding an oil solution such as a fiber treating agent and a softener to the core-sheath conjugate fiber for artificial hair. Examples of the fiber treating agent include a silicone-based fiber treating agent and a non-silicone-based fiber treating agent for improving the touch and the combing property.

The core-sheath conjugate fiber for artificial hair may be subjected to gear crimping. In this case, it is possible to make the fiber gently curved and have a natural appearance, and to reduce the contact between fibers, thereby improving the combing property. In the gear crimping, typically, a fiber heated to the softening temperature or more is caused to pass through a portion between two meshing gears, so that the shape of the gears is transferred to the fiber, and the fiber can be thus curved.

From the viewpoint of using the core-sheath conjugate fiber for artificial hair favorably as an alternative to human hair, the core-sheath conjugate fiber for artificial hair has a single fiber fineness of preferably 10 dtex or more and 200 dtex or less, more preferably 30 dtex or more and 180 dtex or less, even more preferably 40 dtex or more and 150 dtex or less, and even more preferably 50 dtex or more and 100 dtex or less.

In a mass of the core-sheath conjugate fibers for artificial hair, e.g., a fiber bundle of the core-sheath conjugate fibers for artificial hair, all fibers do not necessarily have to have the same fineness and the same cross sectional shape, and fibers having different values of fineness and different cross sectional shapes may be mixed.

### Hair Ornament Product

The core-sheath conjugate fiber for artificial hair can be used for a hair ornament product. There is no particular limitation on the hair ornament product, and it is possible to use the core-sheath conjugate fiber for hair wigs, hairpieces, weaving hair, hair extensions, braided hair, hair accessories, doll hair, and the like, for example.

The hair ornament product may be constituted only by the core-sheath conjugate fiber for artificial hair of one or more embodiments of the present invention. Alternatively, the hair ornament product may be comprised of the core-sheath conjugate fiber for artificial hair of one or more embodiments of the present invention combined with other fibers for artificial hair and natural fibers such as human hair and animal hair.

### EXAMPLES

Hereinafter, one or more embodiments of the present invention will be more specifically described by way of examples. Note that one or more embodiments of the present invention are not limited to these examples.

The measuring methods and the evaluation methods used in the examples and comparative examples are as follows.

### Single Fiber Fineness

The measurement was performed using an autovibro type fineness measuring apparatus “Denier Computer type DC-11” (manufactured by Search), and an average of measured values of 30 samples was calculated and taken as the single fiber fineness.

### Touch

Sensory evaluation by professional hairstylists was performed in four stages below.
A: Very good touch similar to that of human hair
B: Good touch although it is slightly poor compared with that of human hair
C: Bad touch that is poor compared with that of human hair
D: Bad touch that is significantly poor compared with that of human hair

### Combing Property

Fibers whose curls were completely stretched were cut to have a length of 70 cm, and 25 g of thus obtained fibers with a fiber length of 70 cm was bundled. Subsequently, the fiber bundle was bound with a string at the middle thereof, folded in half, and fixed at the string portion, and thus a fiber bundle for hair iron treatment was prepared. Next, the fiber bundle was heated and crimped five times from the root at which the fiber bundle was fixed to the ends, using a hair iron (“Izunami ITC450 flat iron” manufactured by Izunami. Inc, U.S.) heated to 180° C., and thus a fiber bundle for combing property evaluation was prepared. Subsequently, a comb for combing hair (“Matador Professional 386.8 1/2F” made in Germany) was passed through the fiber bundle for combing property evaluation 100 times from the root at which the fiber bundle was fixed to the ends, and the combing property was evaluated according to the following criteria based on the number of fibers deformed or split.
A: Number of fibers deformed or split after a comb is passed through the fibers 100 times is less than 10, and the comb can be passed through the fibers to the ends without resistance.
B: Number of fibers deformed or split after a comb is passed through the fibers 100 times is 10 or more and less than 30, and the comb can be passed through the fibers although the resistance somewhat significantly increases during the passing process.
C: Number of fibers deformed or split after a comb is passed through the fibers 100 times is 30 or more and less than 100, and the comb cannot be passed through the fibers once or more and less than 20 times due to the resistance having increased during the passing process.
D: Number of fibers deformed or split after a comb is passed through the fibers 100 times is 100 or more, and the comb cannot be passed through the fibers 20 times or more due to the resistance having increased during the passing process.

### Gloss

Sensory evaluation through visual observation was performed in four stages below.
A: Gloss disappeared very well when compared with a nylon single fiber and is very close to the gloss of human hair.
B: Gloss disappeared well when compared with a nylon single fiber and is close to the gloss of human hair.
C: Gloss has not disappeared very much when compared with a nylon single fiber or has disappeared too much, and differs from the gloss of human hair.
D: Gloss has not disappeared when compared with a nylon single fiber or has disappeared excessively, and considerably differs from the gloss of human hair.

### Flame Retardance

Fibers were cut to have a length of 17 to 18 cm, and 8 samples each constituted by 0.25 g of the obtained fibers with the fiber length of 17 to 18 cm were weighed. Subsequently, strings (n=8) were produced by holding ends of fibers of each sample and folding the fibers in half while twisting the fibers. The limiting oxygen index (LOI value) of fiber was measured for the produced strings using an oxygen index combustion test machine. The LOI value is taken as an oxygen concentration that is needed for 5 cm of the string to burn or the string to keep burning for 3 minutes. The measurement was performed with the flow rates of oxygen and nitrogen set to predetermined rates, and the LOI value was calculated using the following formula. The “extinction count” indicates the number of strings of which fibers did not burn or stopped burning before 5 cm of the strings burned.

LOI value=0.5÷8×(extinction count)+oxygen concentration (%)

Flame retardance was evaluated in four stages below based on the measured LOI value.
A: 26 or more
B: 25 or more and 25.9 or less
C: 24 or more and 24.9 or less
D: 23.9 or less

### Example 1

30 parts by weight of a brominated epoxy-based flame retardant (product name “SR-T2MP” manufactured by Sakamoto Yakuhin Kogyo Co., Ltd.), 3 parts by weight of sodium antimonate (product name “SA-A” manufactured by NIHON SEIKO CO., LTD.), 2.1 parts by weight of black pigment masterbatch (product name “PESM22367BLACK (20)” manufactured by Dainichiseika Color & Chemicals Mfg. Co., Ltd., pigment: 20% by weight, base resin: polyester-based resin), 0.8 parts by weight of yellow pigment masterbatch (product name “PESM1001YELLOW (20)” manufactured by Dainichiseika Color & Chemicals Mfg. Co., Ltd., pigment: 20% by weight, base resin: polyester-based resin), and 0.6 parts by weight of red pigment masterbatch (product name “PESM3005RED (20)” manufactured by Dainichiseika Color & Chemicals Mfg. Co., Ltd., pigment: 20% by weight, base resin: polyester-based resin) were added with respect to 100 parts by weight of polyethylene terephthalate pellets (EastPET product name “A-12” manufactured by East West Chemical Private Limited), the mixture was dry blended, then supplied to a twin-screw extruder, melt-kneaded at a barrel setting temperature of 280° C., and pelletized, and thus a polyester-based resin composition was obtained.

Next, 12 parts by weight of a brominated epoxy-based flame retardant (product name “SR-T2MP” manufactured by Sakamoto Yakuhin Kogyo Co., Ltd.), 2 parts by weight of sodium antimonate (product name “SA-A” manufactured by NIHON SEIKO CO., LTD.), 2.1 parts by weight of black pigment masterbatch (product name “PESM22367BLACK (20)” manufactured by Dainichiseika Color & Chemicals Mfg. Co., Ltd.), 0.8 parts by weight of yellow pigment masterbatch (product name “PESM1001YELLOW (20)” manufactured by Dainichiseika Color & Chemicals Mfg. Co., Ltd.), and 0.6 parts by weight of red pigment masterbatch (product name “PESM3005RED (20)” manufactured by Dainichiseika Color & Chemicals Mfg. Co., Ltd.) were added with respect to 100 parts by weight of Nylon 6 (product name “A1030BRL” manufactured by UNITIKA LTD.), the mixture was dry blended, then supplied to a twin-screw extruder, melt-kneaded at a barrel setting temperature of 260° C., and pelletized, and thus a polyamide-based resin composition was obtained.

Next, the polyester-based resin composition and the polyamide-based resin composition in the form of pellets obtained as described above were supplied to extruders, extruded from a concentric core-sheath conjugate spinning nozzle (number of pores: 120, pore diameter: 1.5 mm) at a set temperature of 270° C., and wound up at a speed of 40 to 200 m/min, and thus undrawn yarns of core-sheath conjugate fibers each including a core part comprised of the polyester-based resin composition and a sheath part comprised of the polyamide-based resin composition and having a core-to-sheath area ratio of 5:5 were obtained.

The obtained undrawn yarns were drawn to 3 times while being wound up at a speed of 45 m/min using a heat roll at 85° C., and subsequently heat-treated by being wound up at a speed of 45 m/min using a heat roll heated to 205° C. After application of a polyether-based oil solution (product name “KWC-Q” manufactured by Marubishi Oil Chemical Corporation) in an amount of 0.20% omf (by oil pure weight percentage with respect to the dry fiber weight), the yarns were dried, and thus a core-sheath conjugate fiber (single fiber fineness: 175 dtex) was obtained. The obtained core-sheath conjugate fiber for artificial hair had a concentric structure in which the core part 10 was arranged concentrically with the fiber 1, and both the cross sectional shape of the core-sheath conjugate fiber 1 for artificial hair and the cross sectional shape of the core part 10 were circular shapes as shown in the FIGURE.

### Example 2

A core-sheath conjugate fiber (single fiber fineness: 175 dtex) was obtained in a similar way to that of Example 1, except that, in the core part resin composition, the addition amount of the brominated epoxy-based flame retardant was changed to 35 parts by weight and the addition amount of sodium antimonate was changed to 5 parts by weight, and in the sheath part resin composition, the addition amount of the brominated epoxy-based flame retardant was changed to 15 parts by weight and the addition amount of sodium antimonate was changed to 3 parts by weight.

### Example 3

A core-sheath conjugate fiber (single fiber fineness: 175 dtex) was obtained in a similar way to that of Example 1, except that the addition amount of the brominated epoxy-based flame retardant was changed to 20 parts by weight in the sheath part resin composition.

### Example 4

A core-sheath conjugate fiber (single fiber fineness: 175 dtex) was obtained in a similar way to that of Example 1, except that, in the core part resin composition, the addition amount of the brominated epoxy-based flame retardant was changed to 20 parts by weight and the addition amount of sodium antimonate was changed to 2 parts by weight, Nylon 66 (product name “AMILAN CM3001” manufactured by Toray Industries, Inc.) was used as the main component resin of the sheath part resin composition, in the sheath part resin composition, 10 parts by weight of the brominated epoxy-based flame retardant, 1 part by weight of sodium antimonate, 2.1 parts by weight of black pigment masterbatch, 0.8 parts by weight of yellow pigment masterbatch, and 0.6 parts by weight of red pigment masterbatch were added with respect to 100 parts by weight of Nylon 66, and the mixture was dry blended, then supplied to the twin-screw extruder, melt-kneaded at a barrel setting temperature of 280° C., and pelletized to obtain a polyamide-based resin composition.

### Example 5

A conjugate fiber (single fiber fineness: 185 dtex) was obtained in a similar way to that of Example 1, except that, in the core part resin composition, the addition amount of the brominated epoxy-based flame retardant was changed to 20 parts by weight and the addition amount of sodium antimonate was changed to 2 parts by weight, in the sheath part resin composition, the addition amount of the brominated epoxy-based flame retardant was changed to 15 parts by weight and the addition amount of sodium antimonate was changed to 1 part by weight, and the core-to-sheath area ratio was changed to 7:3.

### Example 6

A core-sheath conjugate fiber (single fiber fineness: 165 dtex) was obtained in a similar way to that of Example 1, except that polybutylene terephthalate pellets (product name “NOVADURAN 5020” manufactured by Mitsubishi Chemical Corporation) were used as resin in the core part, in the core part resin composition, 30 parts by weight of the brominated epoxy-based flame retardant, 3 parts by weight of sodium antimonate, 2.1 parts by weight of black pigment masterbatch, 0.8 parts by weight of yellow pigment masterbatch, and 0.6 parts by weight of red pigment masterbatch were added with respect to 100 parts by weight of polybutylene terephthalate pellets, the mixture was dry blended, then supplied to the twin-screw extruder, melt-kneaded at a barrel setting temperature of 260° C., and pelletized, the nozzle setting temperature was changed to 260° C., and the core-to-sheath area ratio was changed to 3:7.

### Comparative Example 1

A core-sheath conjugate fiber (single fiber fineness: 175 dtex) was obtained in a similar way to that of Example 1, except that, in the sheath part resin composition, 2.1 parts by weight of black pigment masterbatch, 0.8 parts by weight of yellow pigment masterbatch, and 0.6 parts by weight of red pigment masterbatch were added with respect to 100 parts by weight of Nylon 6, and the mixture was dry blended, then supplied to the twin-screw extruder, melt-kneaded at a barrel setting temperature of 260° C., and pelletized.

### Comparative Example 2

A core-sheath conjugate fiber (single fiber fineness: 175 dtex) was obtained in a similar way to that of Example 1, except that, in the core part resin composition, 2.1 parts by weight of black pigment masterbatch, 0.8 parts by weight of yellow pigment masterbatch, and 0.6 parts by weight of red pigment masterbatch were added with respect to 100 parts by weight of polyethylene terephthalate pellets, and the mixture was dry blended, then supplied to the twin-screw extruder, melt-kneaded at a barrel setting temperature of 270° C., and pelletized.

### Comparative Example 3

A core-sheath conjugate fiber (single fiber fineness: 165 dtex) was obtained in a similar way to that of Example 1, except that, in the core part resin composition, the addition amount of the brominated epoxy-based flame retardant was changed to 40 parts by weight and the addition amount of sodium antimonate was changed to 4 parts by weight with respect to 100 parts by weight of polyethylene terephthalate pellets, in the sheath part resin composition, the addition amount of the brominated epoxy-based flame retardant was changed to 30 parts by weight and the addition amount of sodium antimonate was changed to 3 parts by weight with respect to 100 parts by weight of Nylon 6, and the core-to-sheath area ratio was changed to 3:7.

### Comparative Example 4

A core-sheath conjugate fiber (single fiber fineness: 175 dtex) was obtained in a similar way to that of Example 1, except that, in the core part resin composition, the addition amount of the brominated epoxy-based flame retardant was changed to 16 parts by weight and the addition amount of sodium antimonate was changed to 2 parts by weight with respect to 100 parts by weight of polyethylene terephthalate pellets.

### Comparative Example 5

A core-sheath conjugate fiber (single fiber fineness: 175 dtex) was obtained in a similar way to that of Example 1, except that, in the sheath part resin composition, the addition amount of the brominated epoxy-based flame retardant was changed to 7 parts by weight and the addition amount of sodium antimonate was changed to 1 part by weight with respect to 100 parts by weight of Nylon 6.

### Comparative Example 6

A core-sheath conjugate fiber (single fiber fineness: 175 dtex) was obtained in a similar way to that of Example 1, except that, in the core part resin composition, the addition amount of the brominated epoxy-based flame retardant was changed to 10 parts by weight and the addition amount of sodium antimonate was changed to 1 part by weight with respect to 100 parts by weight of polyethylene terephthalate pellets, and in the sheath part resin composition, the addition amount of the brominated epoxy-based flame retardant was changed to 5 parts by weight and the addition amount of sodium antimonate was changed to 1 part by weight with respect to 100 parts by weight of Nylon 6.

### Comparative Example 7

A core-sheath conjugate fiber (single fiber fineness: 175 dtex) was obtained in a similar way to that of Example 1, except that, in the core part resin composition, the addition amount of the brominated epoxy-based flame retardant was changed to 30 parts by weight and the addition amount of sodium antimonate was changed to 0 parts by weight with respect to 100 parts by weight of polyethylene terephthalate pellets.

### Comparative Example 8

A core-sheath conjugate fiber (single fiber fineness: 175 dtex) was obtained in a similar way to that of Example 1, except that, in the sheath part resin composition, the addition amount of the brominated epoxy-based flame retardant was changed to 12 parts by weight and the addition amount of sodium antimonate was changed to 0 parts by weight with respect to 100 parts by weight of Nylon 6.

The touch, combing property, gloss, and flame retardance of the core-sheath conjugate fibers for artificial hair of the examples and comparative examples were evaluated as described above. Tables 1 and 2 show the results.

TABLE 1

| | | Ex. 1 | Ex. 2 | Ex. 3 | Ex. 4 | Ex. 5 | Ex. 6 |
|---|---|---|---|---|---|---|---|
| Main component resin of core part | | PET | PET | PET | PET | PET | PBT |
| Amount in | Main component resin | 100 | 100 | 100 | 100 | 100 | 100 |
| core part | Bromine-based flame retardant | 30 | 35 | 30 | 20 | 20 | 30 |
| composition | Flame retardant auxiliary | 3 | 5 | 3 | 2 | 2 | 3 |
| (parts by | Total amount of bromine-based | 33 | 40 | 33 | 22 | 22 | 33 |
| weight) | flame retardant and flame | | | | | | |
| | retardant auxiliary | | | | | | |
| Main component resin of sheath part | | PA6 | PA6 | PA6 | PA66 | PA6 | PA6 |
| Amount in | Main component resin | 100 | 100 | 100 | 100 | 100 | 100 |
| sheath part | Bromine-based flame retardant | 12 | 15 | 20 | 10 | 15 | 12 |
| composition | Flame retardant auxiliary | 2 | 3 | 2 | 1 | 1 | 2 |
| (parts by | Total amount of bromine-based | 14 | 18 | 22 | 11 | 16 | 14 |
| weight) | flame retardant and flame | | | | | | |
| | retardant auxiliary | | | | | | |
| Core-to-sheath ratio (area ratio) | | 5:5 | 5:5 | 5:5 | 5:5 | 7:3 | 3:7 |
| Amount in | Main component resin of core part | 50 | 50 | 50 | 50 | 70 | 30 |
| core-sheath | Main component resin of sheath | 50 | 50 | 50 | 50 | 30 | 70 |
| conjugate | part | | | | | | |
| fiber for | Total amount of main component | 100 | 100 | 100 | 100 | 100 | 100 |
| artificial | resins | | | | | | |
| hair (parts | Total amount of bromine-based | 23.5 | 29.0 | 27.5 | 16.5 | 20.2 | 19.7 |
| by weight) | flame retardant and flame | | | | | | |
| | retardant auxiliary | | | | | | |
| Core-sheath | Touch | A | A | B | B | B | B |
| conjugate | Combing property | B | B | B | A | A | B |
| fiber for | Gloss | A | A | B | A | A | A |
| artificial | Flame retardance | A | A | A | B | B | B |
| hair | | | | | | | |

TABLE 2

| | | Com | Com. | Com. | Com. | Com. | Com. | Com. | Com. |
|---|---|---|---|---|---|---|---|---|---|
| | | Ex. 1 | Ex. 2 | Ex. 3 | Ex. 4 | Ex. 5 | Ex. 6 | Ex. 7 | Ex. 8 |
| Main component resin of core part | | PET | PET | PET | PET | PET | PET | PET | PET |
| Amount in | Main component resin | 100 | 100 | 100 | 100 | 100 | 100 | 100 | 100 |
| core part | Bromine-based flame | 30 | 0 | 40 | 16 | 30 | 10 | 30 | 30 |
| composition | retardant | | | | | | | | |
| (parts by | Flame retardant | 3 | 0 | 4 | 2 | 3 | 1 | 0 | 3 |
| weight) | auxiliary | | | | | | | | |
| | Total amount of | 33 | 0 | 44 | 18 | 33 | 11 | 30 | 33 |
| | bromine-based flame | | | | | | | | |
| | retardant and flame | | | | | | | | |
| | retardant auxiliary | | | | | | | | |
| Main component resin of sheath part | | PA6 | PA6 | PA6 | PA6 | PA6 | PA6 | PA6 | PA6 |
| Amount in | Main component resin | 100 | 100 | 100 | 100 | 100 | 100 | 100 | 100 |
| sheath part | Bromine-based flame | 0 | 12 | 30 | 12 | 7 | 5 | 12 | 12 |
| composition | retardant | | | | | | | | |
| (parts by | Flame retardant | 0 | 2 | 3 | 2 | 1 | 1 | 2 | 0 |
| weight) | auxiliary | | | | | | | | |
| | Total amount of | 0 | 14 | 33 | 14 | 8 | 6 | 14 | 12 |
| | bromine-based flame | | | | | | | | |
| | retardant and flame | | | | | | | | |
| | retardant auxiliary | | | | | | | | |
| Core-to-sheath ratio (area ratio) | | 5:5 | 5:5 | 3:7 | 5:5 | 5:5 | 5:5 | 5:5 | 5:5 |
| Amount in | Main component resin of | 50 | 50 | 30 | 50 | 50 | 50 | 50 | 50 |
| core-sheath | core part | | | | | | | | |
| conjugate | Main component resin of | 50 | 50 | 70 | 50 | 50 | 50 | 50 | 50 |
| fiber for | sheath part | | | | | | | | |
| artificial | Total amount of main | 100 | 100 | 100 | 100 | 100 | 100 | 100 | 100 |
| hair (parts | component resins | | | | | | | | |
| by weight) | Total amount of | 16.5 | 7.0 | 36.3 | 16 | 20.5 | 8.5 | 22 | 22.5 |
| | bromine-based flame | | | | | | | | |
| | retardant and flame | | | | | | | | |
| | retardant auxiliary | | | | | | | | |
| Core-sheath | Touch | A | B | D | A | A | A | A | A |
| conjugate | Combing property | A | B | C | B | A | A | B | A |
| fiber for | Gloss | B | C | D | B | B | C | B | B |
| artificial | Flame retardance | C | D | A | C | C | D | C | C |
| hair | | | | | | | | | |

As can be seen from Table 1, the core-sheath conjugate fibers for artificial hair of Examples 1 to 6 had good touch and combing property, appearance (gloss) close to that of human hair, and also exhibited good flame retardance.

On the other hand, as can be seen from Table 2, in the case of Comparative Example 1 in which the flame retardant and the flame retardant auxiliary were not added to the sheath part, the fiber had good touch, combing property, and gloss, but the flame retardance of the fiber was poor because the flame retardant and the flame retardant auxiliary were not added to the sheath part. In the case of Comparative Example 2 in which the flame retardant and the flame retardant auxiliary were not added to the core part, the fiber had good touch and combing property, but the appearance (gloss) of the fiber was unnatural and the flame retardance of the fiber was poor because the flame retardant and the flame retardant auxiliary were not added to the core part. In the case of Comparative Example 3 in which the flame retardant and the flame retardant auxiliary were added excessively to the core part and the sheath part, both the touch and combing property of the fiber were poor and the appearance of the fiber was unnatural because the amounts of the flame retardant and the flame retardant auxiliary were excessively large. In the case of Comparative Example 4 in which only small amounts of the flame retardant and the flame retardant auxiliary were added to the core part, the fiber had good touch, combing property, and gloss, but the flame retardance of the fiber was poor because the amounts of the flame retardant and the flame retardant auxiliary contained in the core part were small. In the case of Comparative Example 5 as well in which only small amounts of the flame retardant and the flame retardant auxiliary were added to the sheath part, the fiber had good touch, combing property, and gloss, but the flame retardance of the fiber was poor because the amounts of the flame retardant and the flame retardant auxiliary contained in the sheath part were small. In the case of Comparative Example 6 in which the total amount of the flame retardant and the flame retardant auxiliary added to the core part and the sheath part was small, the fiber had good touch and combing property, but the appearance (gloss) of the fiber was unnatural and the flame retardance of the fiber was poor because the amount of the flame retardant and the flame retardant auxiliary was small. In the case of Comparative Example 7 in which the flame retardant auxiliary was not added to the core part, the fiber had good touch, combing property, and gloss, but the flame retardance of the fiber was poor because the core part did not contain the flame retardant auxiliary. In the case of Comparative Example 8 as well in which the flame retardant auxiliary was not added to the sheath part, the fiber had good touch, combing property, and gloss, but the flame retardance of the fiber was poor because the sheath part did not contain the flame retardant auxiliary

One or more embodiments of the present invention may include at least the following embodiments, although there is no particular limitation thereto.

[1] A core-sheath conjugate fiber for artificial hair including a core part and a sheath part,

wherein both the core part and the sheath part contain a bromine-based flame retardant and a flame retardant auxiliary,

the core part is comprised of a core part resin composition that contains the bromine-based flame retardant and the flame retardant auxiliary in a total amount of 20 parts by weight or more and 40 parts by weight or less with respect to 100 parts by weight of a main component resin,

the sheath part is comprised of a sheath part resin composition that contains the bromine-based flame retardant and the flame retardant auxiliary in a total amount of 10 parts by weight or more and 25 parts by weight or less with respect to 100 parts by weight of a main component resin, and

when the total amount of the main component resin of the core part and the main component resin of the sheath part is taken as 100 parts by weight, the core-sheath conjugate fiber for artificial hair contains the bromine-based flame retardant and the flame retardant auxiliary in a total amount of 10 parts by weight or more and 35 parts by weight or less.

[2] The core-sheath conjugate fiber for artificial hair according to [1], wherein the main component resin of the core part is a polyester-based resin, and the main component resin of the sheath part is a polyamide-based resin.

[3] The core-sheath conjugate fiber for artificial hair according to [1] or [2], wherein a core-to-sheath area ratio is core:sheath=2:8 to 7:3.

[4] The core-sheath conjugate fiber for artificial hair according to [2] or [3], wherein the polyester-based resin is one or more of polyester-based resins selected from the group consisting of polyalkylene terephthalate and a copolymerized polyester mainly containing polyalkylene terephthalate.

[5] The core-sheath conjugate fiber for artificial hair according to any one of [2] to [4], wherein the polyamide-based resin is a polyamide-based resin mainly containing at least one selected from the group consisting of Nylon 6 and Nylon 66.

[6] The core-sheath conjugate fiber for artificial hair according to any one of [1] to [5], wherein the total amount of the bromine-based flame retardant and the flame retardant auxiliary with respect to 100 parts by weight of the main component resin in the sheath part resin composition is smaller than the total amount of the bromine-based flame retardant and the flame retardant auxiliary with respect to 100 parts by weight of the main component resin in the core part resin composition.

[7] The core-sheath conjugate fiber for artificial hair according to any one of [1] to [6], wherein the core part resin composition contains the bromine-based flame retardant in an amount of 20 parts by weight or more and 35 parts by weight or less with respect to 100 parts by weight of the main component resin.

[8] The core-sheath conjugate fiber for artificial hair according to any one of [1] to [7], wherein the core part resin composition contains the flame retardant auxiliary in an amount of 2 parts by weight or more and 5 parts by weight or less with respect to 100 parts by weight of the main component resin.

[9] The core-sheath conjugate fiber for artificial hair according to any one of [1] to [8], wherein the sheath part resin composition contains the bromine-based flame retardant in an amount of 10 parts by weight or more and 20 parts by weight or less with respect to 100 parts by weight of the main component resin.

[10] The core-sheath conjugate fiber for artificial hair according to any one of [1] to [9], wherein the sheath part resin composition contains the flame retardant auxiliary in an amount of 1 part by weight or more and 3 parts by weight or less with respect to 100 parts by weight of the main component resin.

[11] A hair ornament product including the core-sheath conjugate fiber for artificial hair according to any one of [1] to [10].

[12] The hair ornament product according to [11], wherein the hair ornament product is one selected from the group consisting of a hair wig, a hairpiece, weaving hair, a hair extension, braided hair, a hair accessory, and doll hair.

### LIST OF REFERENCE NUMERALS

1 Core-sheath conjugate fiber for artificial hair

10 Core part

20 Sheath part

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. A core-sheath conjugate fiber for artificial hair comprising:
a core part; and
a sheath part,
wherein:
both the core part and the sheath part contain a bromine-based flame retardant and a flame retardant auxiliary,
the core part is comprised of a core part resin composition that comprises the bromine-based flame retardant and the flame retardant auxiliary in a total amount of 20 parts by weight or more and 40 parts by weight or less with respect to 100 parts by weight of a main component resin,
the sheath part is comprised of a sheath part resin composition that comprises the bromine-based flame retardant and the flame retardant auxiliary in a total amount of 10 parts by weight or more and 25 parts by weight or less with respect to 100 parts by weight of a main component resin,
when the total amount of the main component resin of the core part and the main component resin of the sheath part is taken as 100 parts by weight, the core-sheath conjugate fiber for artificial hair comprises the bromine-based flame retardant and the flame retardant auxiliary in a total amount of 10 parts by weight or more and 35 parts by weight or less, and
the total amount of the bromine-based flame retardant and the flame retardant auxiliary with respect to 100 parts by weight of the main component resin in the sheath part resin composition is smaller than the total amount of the bromine-based flame retardant and the flame retardant auxiliary with respect to 100 parts by weight of the main component resin in the core part resin composition.

2. The core-sheath conjugate fiber for artificial hair according to claim 1, wherein the main component resin of the core part is a polyester-based resin, and the main component resin of the sheath part is a polyamide-based resin.

3. The core-sheath conjugate fiber for artificial hair according to claim 1, wherein a core-to-sheath area ratio is core:sheath=2:8 to 7:3.

4. The core-sheath conjugate fiber for artificial hair according to claim 2, wherein the polyester-based resin is one or more of polyester-based resins selected from the group consisting of polyalkylene terephthalate and a copolymerized polyester mainly containing polyalkylene terephthalate.

5. The core-sheath conjugate fiber for artificial hair according to claim 2, wherein the polyamide-based resin mainly contains at least one selected from the group consisting of Nylon 6 and Nylon 66.

6. The core-sheath conjugate fiber for artificial hair according to claim 1, wherein the core part resin composition comprises the bromine-based flame retardant in an amount of 20 parts by weight or more and 35 parts by weight or less with respect to 100 parts by weight of the main component resin.

7. The core-sheath conjugate fiber for artificial hair according to claim 1, wherein the core part resin composition comprises the flame retardant auxiliary in an amount of 2 parts by weight or more and 5 parts by weight or less with respect to 100 parts by weight of the main component resin.

8. The core-sheath conjugate fiber for artificial hair according to claim 1, wherein the sheath part resin composition comprises the bromine-based flame retardant in an amount of 10 parts by weight or more and 20 parts by weight or less with respect to 100 parts by weight of the main component resin.

9. The core-sheath conjugate fiber for artificial hair according to claim 1, wherein the sheath part resin composition comprises the flame retardant auxiliary in an amount of 1 part by weight or more and 3 parts by weight or less with respect to 100 parts by weight of the main component resin.

10. The core-sheath conjugate fiber for artificial hair according to claim 1, wherein in both the core part resin composition and the sheath part resin composition, the bromine-based flame retardant comprises a brominated epoxy-based flame retardant.

11. The core-sheath conjugate fiber for artificial hair according to claim 1, wherein in both the core part resin composition and the sheath part resin composition, the flame retardant auxiliary comprises sodium antimonate.

12. A hair ornament product comprising the core-sheath conjugate fiber for artificial hair according to claim 1.

13. The hair ornament product according to claim 12, wherein the hair ornament product is one selected from the group consisting of a hair wig, a hairpiece, weaving hair, a hair extension, braided hair, a hair accessory, and doll hair.

14. The hair ornament product according to claim 12, wherein the main component resin of the core part is a polyester-based resin, and the main component resin of the sheath part is a polyamide-based resin.

15. The hair ornament product according to claim 14, wherein the polyester-based resin is one or more of polyester-based resins selected from the group consisting of polyalkylene terephthalate and a copolymerized polyester mainly containing polyalkylene terephthalate.

16. The hair ornament product according to claim 14, wherein the polyamide-based resin mainly contains at least one selected from the group consisting of Nylon 6 and Nylon 66.

17. The hair ornament product according to claim 12, wherein the core-sheath conjugate fiber has a core-to-sheath area ratio of core:sheath=2:8 to 7:3.

18. The hair ornament product according to claim 12, wherein the sheath part resin composition comprises the flame retardant auxiliary in an amount of 1 part by weight or more and 3 parts by weight or less with respect to 100 parts by weight of the main component resin.

19. The hair ornament product according to claim 12, wherein in both the core part resin composition and the sheath part resin composition, the bromine-based flame retardant comprises a brominated epoxy-based flame retardant.

20. The hair ornament product according to claim 12, wherein in both the core part resin composition and the sheath part resin composition, the flame retardant auxiliary comprises sodium antimonate.
